(19) United States
(12) Patent Application Publication
(10) Pub. No.: US 2024/0230082 A9
(43) Pub. Date: Jul. 11, 2024

(54) CARBON-DIOXIDE SUPPLIER

(71) Applicant: Pil-soo JEONG, Jangseong-gun, Jeollanam-do (KR)

(72) Inventor: Pil-soo JEONG, Jangseong-gun, Jeollanam-do (KR)

(21) Appl. No.: 18/278,418

(22) PCT Filed: Feb. 23, 2022
(86) PCT No.: PCT/KR2022/002631

§ 371 Date: Aug. 23, 2023

(30) Foreign Application Priority Data
Feb. 23, 2021 (KR) 10-2021-0024406

(51) Int. Cl. F23D 14/18; B01F 23/10; B01F 25/10

(52) U.S. Cl. CPC F23D 14/18; B01F 23/10; B01F 25/10; B01F 2101/501

(57) ABSTRACT

The present invention provides a carbon dioxide supplier capable of forming a swirl flow of a mixture gas and evenly distributing the mixture gas through porous grating hole of a catalyst for catalyst combustion to maintain uniform temperature throughout the entire volume of the catalyst to maintain stable combustion of carbon. The carbon dioxide supplier comprises: a mixture gas supply unit supplying a mixture gas of air and fuel; a combustion unit combusting the mixture gas supplied from the mixture gas supply unit; and a swirl forming unit 40 extending between the mixture gas supply unit 30 and the combustion unit 50 in anteroposterior direction, the swirl forming unit 40 swirl-flowing the mixture gas introduced into a rear portion thereof from the mixture gas supply unit 30 to the combustion unit 50 provided at a front portion thereof.

### TECHNICAL FIELD

The present invention relates to a carbon dioxide supplier, and in particular, relates to a carbon dioxide supplier with excellent startup capability and free of emitting harmful gases even during the initial ignition process, and capable of safe and complete combustion at ultra-lean medium temperature.

### BACKGROUND ART

In general, the photosynthetic rate required for growth of crops for high quality and high yield is greatly influenced by light intensity, temperature and concentration of carbon dioxide (CO₂). Among these, about 380 ppm of carbon dioxide exists in the atmosphere, and horticultural crops absorb carbon dioxide in the atmosphere and photosynthesize to produce assimilable products necessary for crop growth, and the quantity and quality of the crops improve according to the increase or the decrease of the photosynthetic products. That is, the proper supply of carbon dioxide is one of the most important factors in the cultivation of horticultural crops.

However, since ventilation is very limited when crops are grown in the house facility in winter, the carbon dioxide concentration in the house facility is reduced due to the unilateral consumption of carbon dioxide by photosynthesis in the closed cultivation environment. Accordingly, the concentration of carbon dioxide may be lower than the carbon dioxide gas compensation point of the crop, which is a problematic limiting factor in the growth of the crop.

In view of the above problems, conventionally, carbon dioxide was supplied using a liquefied carbonic acid supplying device or a device using combustor during the cultivation of horticultural crops.

Among these, the liquefied carbonic acid supplying device directly supplies liquefied carbonic acid into a house where crops are grown. Since liquefied carbon dioxide is expensive, there is problem of low efficiency in terms of economy. In addition, a conventional device using combustor supplies, to crops, exhaust gas from a combustor such as a boiler or an internal combustion engine. The device using combustor is problematic in that harmful exhaust gases such as NOx, HC (hydrocarbon) and CO (carbon monoxide), which are obstacles to photosynthesis and growth of crops, are generated during the operation of combustor such as a boiler or an internal combustion engine.

Accordingly, the applicant has invented carbon dioxide suppliers disclosed in Korean Patent No. 1652876, Korean Patent No. 1875526 and Korean Patent Application Publication No. 2021-0016193. These carbon dioxide suppliers drastically reduce harmful exhaust gases such as NOx, HC and CO by medium temperature combustion of carbon fuel under lean conditions using a catalyst. However, these carbon dioxide suppliers are problematic in that initial ignition operation is unstable and unexpected misfire occurs during operation.

### SUMMARY OF THE INVENTION

### Technical Problem

It is an object of the invention to solve the above problems by providing a carbon dioxide supplier with stable initial ignition operation.

It is an object of the invention to provide a carbon dioxide supplier in which misfire does not occur during operation.

### Technical Solution

In order to solve the above-described problems, the present invention provides a carbon dioxide supplier capable of forming a swirl flow of a mixture gas and evenly distributing the mixture gas through porous grating hole of a catalyst for catalyst combustion to maintain uniform temperature throughout the entire volume of the catalyst to maintain stable combustion of carbon.

The carbon dioxide supplier comprises: a mixture gas supply unit supplying a mixture gas of air and fuel; a combustion unit combusting the mixture gas supplied from the mixture gas supply unit; and a swirl forming unit 40 extending between the mixture gas supply unit 30 and the combustion unit 50 in anteroposterior direction, the swirl forming unit 40 swirl-flowing the mixture gas introduced into a rear portion thereof from the mixture gas supply unit 30 to the combustion unit 50 provided at a front portion thereof.

The swirl forming unit 40 provides a circular flow cross-section along a direction from the mixture gas supply unit 30 toward the combustion unit 50.

The mixture gas supply unit 30 introduces the mixture gas into the swirl forming unit 40 through a mixture gas inlet pipe 35 connected to the rear portion thereof in a direction inscribed to the circular flow cross-section to form a swirl flow of the mixture gas.

The mixture gas inlet pipe 35 may comprise a straight pipe introducing the mixture gas of straight laminar flow into the swirl forming unit 40.

The mixture gas inlet pipe 35 connected to the swirl forming unit 40 may be inclined forward by a predetermined angle of inflow k with respect to a plane perpendicular to the anteroposterior direction such that the mixture gas supplied from the mixture gas inlet pipe 35 is introduced into the swirl forming unit 40 at a predetermined velocity v having a lateral velocity component of v×cos k and a forward velocity component of v×sin k.

A tapered pipe 42 having an inner diameter increasing toward a forward direction is provided at a portion of the swirl forming unit 40 further forward than where the mixture gas inlet pipe 35 is connected such that a width of the swirl flow of the mixture gas introduced from the mixture gas inlet pipe 35 may be increased from w1 to w2.

A large-diameter pipe 43 having a constant inner diameter and extending in forward direction is connected to a front portion of the tapered pipe 42 to provide a swirl stabilization section C such that the swirl flow of the mixture gas in forward motion through the tapered pipe 42 is stabilized.

A dome cap 412 having an inner surface concaved toward backward direction may be provided at a portion of the swirl forming unit 40 further backward than where the mixture gas inlet pipe 35 is connected. The dome cap 412 may guide a return flow that returns along a center axis from a front end of the swirl forming unit 40 to be redirected forward.

The combustion unit 50 may comprise: a catalyst member 53 installed at a front end of the swirl forming unit 40 and having a plurality of lattice holes 531 extending and penetrating through in the anteroposterior direction; and an ignition heater unit 51 spaced apart from a rear end of the catalyst member 53 in a backward direction by a predetermined distance.

The catalyst member 53 may promote combustion of the mixture gas at a temperature higher than an activation temperature; and

A space corresponding to the predetermined distance may constitute a swirl retention section D where the swirl flow of the mixture gas retains.

The ignition heater unit 51 may include a first heater 511 having flat bar-shape and a second heater 512 having flat bar-shape.

Each of the first heater 511 and the second heater 512 may be provided at a same position with respect to the anteroposterior direction.

The first heater 511 may be disposed further upstream side of the swirl flow in the direction of the swirl flow of the mixture gas than the second heater 512.

Each of the first heater 511 and the second heater 512 may extend in a direction perpendicular to the anteroposterior direction.

The extending direction of the first heater 511 may be parallel to that of the second heater 512.

At least one of the first heater 511 having flat bar-shape and the second heater 512 having flat bar-shape is installed at a predetermined angle of inclination j with respect to the anteroposterior direction corresponding to a direction of the swirl flow.

The first heater 511 may have a predetermined angle of inclination j with respect to the anteroposterior direction corresponding to a direction of the swirl flow.

The second heater 512 may be parallel to the anteroposterior direction or have a predetermined angle of inclination j with respect to the anteroposterior direction corresponding to a direction of the swirl flow.

When the plane including the bar-shaped second heater 512 is parallel to the anteroposterior direction, the planes including the bar-shaped first heater 511 and the bar-shaped second heater 512 may not be parallel to each other.

When the plane including the bar-shaped second heater 512 has a predetermined angle of inclination j with respect to the anteroposterior direction corresponding to a direction of the swirl flow, the planes including the bar-shaped first heater 511 and the bar-shaped second heater 512 may be parallel to each other.

The first heater 511 may laterally cross the upper portion of the flow cross-section, and the second heater 512 may laterally cross the lower portion of the flow cross-section.

The first heater 511 may be installed in the form of a flat bar having a predetermined angle of inclination j and going further downward toward the front.

The second heater 512 may be installed such that the flat bar shape is horizontal.

The first heater 511 may cross the upstream of the swirl flow in vertical direction at the flow cross-section, and the second heater 512 may cross the downstream of the swirl flow in vertical direction at the flow cross-section

The first heater 511 and the second heater 512 may be installed to bee inclined in a direction corresponding to the direction of the swirl flow at a predetermined angle of inclination j.

Each of front ends of the first heater 511 and the second heater 512 may be spaced apart from an inner circumferential surface of the swirl forming unit 40.

The carbon dioxide supplier 1 may further comprise: a temperature sensor 81 detecting a temperature of the catalyst member 53; and a controller 80 controlling the mixture gas supply unit 30 and the ignition heater unit 51.

The controller 80 may perform, for a startup of the carbon dioxide supplier 1, a preheating step, an overlapping step and an operating step.

The controller 80 may perform the preheating step of supplying power to the ignition heater unit 51 to generate heat and of controlling the mixture gas supply unit 30 to supply air until the temperature of the catalyst member 53 reaches a first set temperature lower than the activation temperature.

The controller 80 may perform the overlapping step of maintaining power supply to the ignition heater unit 51 and controlling the mixture gas supply unit 30 to supply the mixture gas when the temperature of the catalyst member 53 is equal to or higher than the first set temperature and equal to or lower than a second set temperature higher than the activation temperature; and

The controller 80 may perform the operating step of cutting off the power supplied to the ignition heater unit 51 to stop generating heat and controlling the mixture gas supply unit 30 to supply the mixture gas when the temperature of the catalyst member 53 is equal to or higher than the second set temperature.

### Advantageous Effects

According to the present invention, by forming the swirl flow of a mixture gas, the mixture gas is evenly burned in all regions of a catalyst member such that the temperature of a catalyst may be maintained uniformly throughout the catalyst, and thus a stable combustion state may be maintained.

According to the present invention, even when a carbon dioxide supplier is horizontally installed, the flow of the mixture gas is prevented from being concentrated on the upper part by utilizing a heater of an ignition heater unit as a vane, thereby combusting the mixture gas evenly in all areas of the catalyst member.

According to the present invention, the mixture gas is controlled to continuously swirls in a swirl retention section provided immediately before the catalyst member such that the heat generated from the combustion of the mixture gas occurring in the catalyst member is evenly transferred to the swirl-flowing mixture gas, and the mixture gas is evenly distributed and introduced into the plurality of grating holes of the catalyst member.

According to the present invention, the mixture gas that swirl-flows in the swirl retention section is introduced and burned more into the grating hole provided on the outer circumference in the radial direction than into the center of the catalyst member such that the amount of heat generated at the circumference of the catalyst member is greater than that of heat generated at the center. Accordingly, a uniform temperature throughout the catalyst member is maintained. Thus, the problem of non-uniformity in the temperature of the catalyst member caused by more heat being transferred to the outer circumference in the radial direction than the center portion of the catalyst member is solved.

According to the present invention, the mixture gas may be preheated before combustion thereof by transferring heat to the mixture gas flowing in the rear through the return flow that returns from the swirl retention section to the rear along the center axis of the swirl forming unit. Accordingly, stable catalytic combustion is possible, thereby further reducing the possibility of misfire.

According to the present invention, due to the startup control step of the controller 80 including the overlap step, the reliability of the startup process of the carbon dioxide supplier may be further increased.

In addition to the advantageous effects described above, specific effects of the present invention will be described further while describing specific details of the present invention.

### BRIEF DESCRIPTION OF DRAWINGS

FIG. 1 is a perspective view showing a first example of a carbon dioxide supplier according to the present invention.

FIG. 2 is a perspective view showing an inside of a housing of the carbon dioxide supplier of FIG. 1 by removing a portion of the housing.

FIGS. 3 and 4 are perspective views showing only a catalytic combustion device of the carbon dioxide supplier shown in FIG. 2.

FIG. 5 is a cross-sectional plan view showing the catalytic combustion device of FIG. 3 without a mixture gas supply unit.

FIGS. 6 and 7 are perspective views showing the catalytic combustion device of FIG. 3 without a support bracket, FIG. 8 is a lateral view thereof, and FIG. 9 is a plan view thereof.

FIG. 10 is a front perspective view showing the catalytic combustion device of FIG. 3 without the support bracket and the mixture gas supply unit, FIG. 11 is a rear view thereof, FIG. 12 is a planar cross-sectional perspective view, FIG. 13 is a cross-sectional plan view thereof, FIG. 14 is a rear perspective view thereof, FIG. 15 is a cross-sectional lateral view thereof, and FIG. 16 is a planar cross-sectional front view thereof.

FIG. 17 is a diagram illustrating a flow of a mixture gas of a carbon dioxide supplier of the present invention.

FIG. 18 is a diagram showing a control panel provided at the housing.

FIGS. 19 through 29 are diagrams illustrating flow analysis results when both flat surfaces of first and second heaters are installed vertically and installed horizontally, and when the first heater is installed at an angle and the second heater is installed horizontally.

FIG. 30 is a perspective view of a second example of a catalytic combustion device of a carbon dioxide supplier according to the present invention.

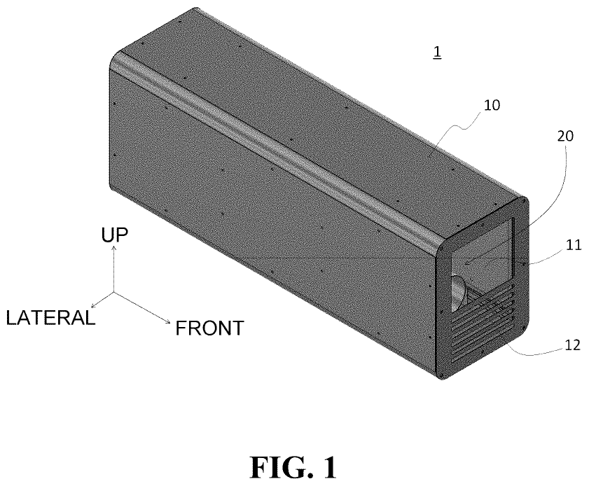

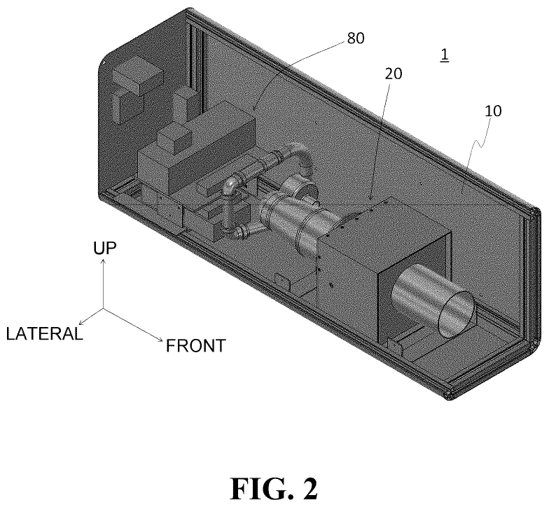

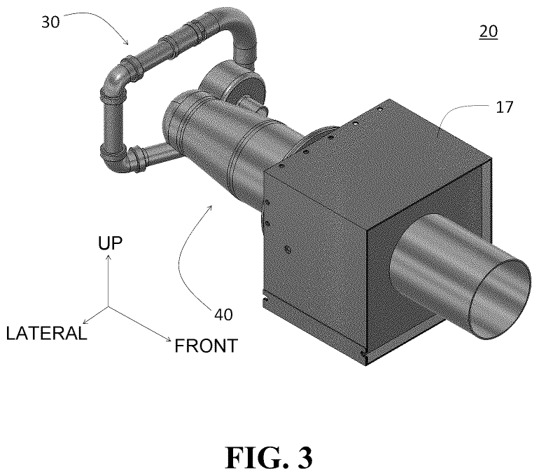

### DESCRIPTION OF REFERENCE NUMERALS

1: carbon dioxide supplier; 10: housing; 11: front outlet; 12: grating; 17: support bracket; 20: catalytic combustion device; 30: mixture gas supply unit; 31: air supply fan (DC FAN); 32: air supply pipe; 33: fuel supply pipe (gas pipe); 34: mixing pipe; 341: junction; 342: mixing section; 343: first direction change unit; 344: second direction change unit; 35: mixture gas inlet pipe k: angle of inflow; 36: fuel tank; 37: valve; 40: swirl forming unit; 41: small-diameter pipe; 411: circular pipe; 412: dome cap; 42: tapered pipe (diffuser); 43: large-diameter pipe; 431: first pipe; 432: second pipe; A: intro section; B: speed-up section; C: swirl stabilization section; D: swirl retention section; 50: combustion unit; 51: ignition heater unit; 511: first heater (inclined at upper portion); j: angle of inclination; 512: second heater (horizontal at lower portion); 52: catalyst unit; 53: catalyst member; 531: grating hole; 54: gasket; 55: combustion exhaust pipe; 80: controller; 81: temperature sensor; 82: flow sensor; 83: weight sensor; 84: fan error lamp; 85: ignition error lamp; 86: low fuel lamp

### DETAILED DESCRIPTION OF THE INVENTION

Hereinafter, preferred embodiments of the present invention will be described in detail with reference to the accompanying drawings.

The present invention is not limited to the embodiments disclosed hereinafter, and various changes may be applied and may be implemented in various different forms. The embodiment herein is only provided to complete the disclosure of the present invention and to fully inform those skilled in the art of the scope of the invention. Therefore, the present invention is not limited to the embodiments disclosed hereinafter, and it should be understood that the present invention includes all changes and equivalents encompassed in the technical spirit and scope of the present invention as well as substitution or addition of a configuration of one embodiment with that of another embodiment.

The accompanying drawings are only for facilitating understanding of the embodiments disclosed herein, and it should be understood that the technical idea disclosed herein is not limited by the accompanying drawings, and that encompasses all changes, equivalents and substitutions of the spirit and technical scope of the present invention.

In the accompanying drawings, while components may be exaggeratedly large or small in size or thickness to facilitate understanding, etc., this should not construe the scope of protection of the present invention as being limited.

Terms used herein are only used to describe specific embodiments or examples, and are not intended to limit the present invention. In addition, the expressions in singular form include expressions in plural form unless the context clearly dictates otherwise. Herein, terms such as “comprise” and “consist of” are intended to designate that features, numbers, steps, operations, components, parts, or combinations thereof described in the specification exist. That is, it should be understood that terms such as “comprise”, “consist of” used herein should not preclude the possibility of the presence or addition of one or more other features, numbers, steps, operations, components, parts, or combinations thereof.

While terms including ordinal numbers such as “first” and “second” may be used to describe various components, the components are not limited by the terms. The terms are only used for the purpose of distinguishing one component from another.

It should be understood that when an element is referred to as being “connected” to another element, the element may be directly connected to another element, or there may exist an interposing element in the middle. On the other hand, when an element is referred to as being “directly connected” to another element, it should be understood that there is no interposing element in the middle.

When an element is referred to as being “above” or “under” another element, it should be understood that there may exist an interposing elements in the middle as well as being directly above or under another element.

Unless defined otherwise, all terms used herein, including technical or scientific terms, have the same meaning as commonly understood by those skilled in the art to which the present invention belongs. Terms such as those defined in commonly used dictionaries should be interpreted as having a meaning consistent with the meaning in the context of the related art, and unless explicitly defined herein, terms such as those defined in commonly used dictionaries should not be interpreted in an ideal or excessively formal meaning.

The carbon dioxide supplier of the embodiment according to the present invention is installed horizontally to elongate in the anteroposterior direction. According to the carbon dioxide supplier, mixture gas is supplied from the rear, and combusted air is discharged to the front. This is advantageous in that hot combustion gas is prevented from damaging the ceiling of the horticultural facility and carbon dioxide gas is uniformly supplied to the horizontally long interior space of the horticultural facility.

The carbon dioxide supplier having a housing extending in the anteroposterior direction is advantageous for the installation in a horticultural facility. Since there is no risk of overturning, a separate wide support is not necessary such that the carbon dioxide supplier occupies small area when installed on the ground is small, and may be installed on crops rather than on the ground due to its low height.

The mixture gas, which is combusted in the carbon dioxide supplier of the embodiment, spirally swirl-flows rotating around the axis of the anteroposterior direction from the rear to the front. That is, in the carbon dioxide supplier of the embodiment, while the mixture gas swirl-flows, the mixture gas actually moves from the rear to the front.

In describing the embodiment, the axial direction may refer to an anteroposterior direction, and the radial direction may refer to a direction away from or toward the axis. The centrifugal direction may refer to a radial direction away from the axis.

In the description of the embodiment, the vertical direction may refer to a direction parallel to the direction of gravity.

Hereinafter, the carbon dioxide supplier 1 of the embodiment will be described with reference to the drawings.

<Housing>

The carbon dioxide supplier 1 of the embodiment may include a catalytic combustion device 20 and a controller 80 accommodated in a housing 10 of a rectangular enclosure elongated in the anteroposterior direction.

The catalytic combustion device 20 is a device that mixes and catalytically combusts gaseous fuel such as LPG with air. The controller 80 is a device that controls the operation of the catalytic combustion device 20.

A front outlet 11 is provided at the front portion of the housing 10. The front outlet 11 serves as a passage through which carbon dioxide gas (CO₂) and water vapor (H₂O) generated by combustion in the catalytic combustion device 20 are discharged forward. Although not shown, a blower type fan may be installed on the top of a support bracket 17 of the catalytic combustion device 20 in the housing 10 to generate a rapid forward air flow such that carbon dioxide gas is discharged farther. However, the type and location of the fan are not limited thereto. For example, in order to further extend the reach of carbon dioxide gas, a blower fan may be placed in the front lower part of the front outlet 11, and a suction type blower fan (inhaling and discharging carbon dioxide gas and vapor) may be installed.

A grating 12 may be installed at the lower portion of the front outlet 11 such that not all hot carbon dioxide gas from the catalytic combustion device 20 are directly discharged to the outside, and the user may be prevented from reaching the vicinity of the exhaust port of the hot catalytic combustion device 20.

<Catalytic Combustion Device>

The catalytic combustion device 20 is fixed inside the housing 10 by the support bracket 17. That is, the catalytic combustion device 20 is fixed to the support bracket 17, and the support bracket 17 is fixed to the housing 10 such that the catalytic combustion device 20 is stably fixed to the housing 10.

The support bracket 17 may have a shape of short rectangular enclosure in the anteroposterior direction. Circular hole is provided on each of the front and rear surfaces of the support bracket 17, and the catalytic combustion device 20 is seated in the holes such that the catalytic combustion device 20 is supported within the housing 10. The support bracket 17 may have a shape that accommodates therein the hottest portion of the catalytic combustion device 20, i.e. the combustion unit 50. Accordingly, the heat generated in the combustion unit 50 may stay in the internal space partitioned by the support bracket 17, and as a result, the degree of transfer of the high-temperature heat of the combustion unit 50 to the housing 10 may be minimized.

In some cases, the support bracket 17 may have an open shape rather than a box-shaped enclosure. For example, when the combustion unit 50 is covered by the support bracket 17 having a form of an enclosure, the catalyst unit 52 may reach an unintended high temperature, disrupting normal operation and reducing the life span of the catalyst. When this is a concern, the support bracket 17 may be designed to have only the function of fixing the catalytic combustion device 20.

The catalytic combustion device 20 includes a mixture gas supply unit 30, a swirl forming unit 40 that induces a swirl flow of the supplied mixture gas, and the combustion unit 50 that combusts the swirl-flowing mixture gas.

The mixture gas supply unit 30 may be disposed behind the catalytic combustion device 20. The mixture gas supply unit 30 includes an air supply fan 31 and an air supply pipe 32 connected to the air supply fan 31. The air supply fan 31 may be a DC FAN to facilitate speed control. The upstream end of the air supply pipe 32 is connected to the air supply fan 31, and the downstream end thereof is connected to a mixing pipe 34.

In addition, the mixture gas supply unit 30 includes a fuel tank 36 and a fuel supply pipe 33 connected to the fuel tank 36. In the drawing, only a portion of the fuel supply pipe 33 is shown for convenience of description. The fuel supply pipe 33 is connected to the mixing pipe 34. Gaseous fuel is supplied to the mixing pipe 34 through the fuel supply pipe 33. However, the present invention does not exclude the use of liquid fuel and solid fuel. That is, as long as the phase of the fuel flowing into the mixing pipe 34 through the fuel supply pipe 33 is gaseous, the fuel stored in the fuel tank 36 may be in liquid phase or solid phase.

The mixing pipe 34 is connected to the air supply pipe 32 and the fuel supply pipe 33. A junction 341 of the mixing pipe 34 where the air supply pipe 32 and the fuel supply pipe 33 are connected includes a T-shaped pipe. As shown, the air supply pipe 32 may be connected in a straight line from the T-shaped pipe, and the fuel supply pipe 33 may join the T pipe laterally.

The mixing pipe 34 includes the junction 341 and a mixing section 342 connected to the downstream side of the junction 341. The mixing section 342 is a section that secures a flow length to an extent such that air and fuel gas may be evenly mixed. The mixing section 342 may be provided with a first direction change unit 343 and a second direction change unit 344 that respectively change the flow direction by about 90 degrees. The direction change units partially cause turbulence in the flow such that fuel gas and air are mixed more evenly.

In addition to the above, the direction change unit allows compact arrangement of pipes around the swirl forming unit 40 inside the housing 10 such that the volume occupied by the device is reduced. For example, the air supply fan 31 and a mixture gas inlet pipe 35 to be described later are disposed opposite to each other with the swirl forming unit 40 interposed therebetween, and the mixture gas supply unit 30 is arranged to surround the rear end of the swirl forming unit 40 forming a “c” shape in compact manner.

The downstream end of the mixing pipe 34 is connected to the mixture gas inlet pipe 35. The mixture gas inlet pipe 35 may be a straight pipe. This induces a straight laminar flow of the mixture gas previously mixed in the mixing pipe 34. That is, it is preferable to ensure that the length of the mixture gas inlet pipe 35 is such that the mixture gas flowing in the mixing pipe 34 may flow in a straight laminar manner. For example, the diameter of the mixture gas inlet pipe 35 may be approximately 1.2 to 2 cm, and the length of the mixture gas inlet pipe 35 may be approximately 5 cm.

The air-to-fuel ratio λ of the mixture gas may be about 2.8 to 3.5, preferably in an ultra-lean state of about 3. In order to achieve this, the controller 80 may control the on/off operation and/or speed of the air supply fan 31, and opening/closing operation and/or opening degree of the valve 37 of the fuel supply pipe 33. While not shown, the valve 37 of the fuel supply pipe 33 may be a solenoid valve equipped with a built-in spring. The solenoid valve may have a structure in which, when power is supplied, magnetic force is generated and the valve is opened by against the elasticity of the spring, and, when power is cut off, the elasticity of the spring restores the valve to be closed. This structure reliably provides a cut-off of fuel supply when a power cut-off such as a power outage occurs.

The mixture gas inlet pipe 35 is connected to the swirl forming unit 40. The swirl forming unit 40 includes a small-diameter pipe 41, a tapered pipe 42, and a large-diameter pipe 43 in order from rear to front.

The small-diameter pipe 41 is connected to the mixture gas inlet pipe 35. The small-diameter pipe 41 may include a circular pipe 411 and a dome cap 412 disposed therebehind.

The mixture gas inlet pipe 35 is connected to the diameter pipe 41 at an angle of inflow k tilted forward by 12 to 24 degrees with respect to the plane perpendicular to the anteroposterior direction in which the swirl forming unit 40 extends. Preferably, the angle of inflow k may be 15 to 20 degrees. The mixture gas inlet pipe 35, as shown in FIG. 11, is tangentially connected to the small-diameter pipe 41.

The dome cap 412 has a hemispherical inner surface. This structure helps the return flow of the mixture gas, which will be described later, be redirected forward.

The tapered pipe 42 is connected to the front portion of the small-diameter pipe 41, and has a truncated cone shape whose diameter gradually increases toward the front portion thereof. The slope at which the diameter of the tapered pipe 42 increases may be about 7 to 12 degrees. Preferably, the slope may be about 8 to 10 degrees. The tapered pipe 42 functions as a diffuser.

The mixture gas discharged from the mixture gas inlet pipe 35 and introduced into the small-diameter pipe 41 flows obliquely forward and in a direction in contact with the inner circumferential surface of the small-diameter pipe 41, and then flows spirally along the inner circumferential surface of the tapered pipe 42. The swirl flow of the mixture gas in the tapered pipe 42 is accelerated.

A large-diameter pipe 43 is connected to the front portion of the tapered pipe 42. The diameter of the large-diameter pipe 43 may be about 1.3 to 1.5 times the diameter of the small-diameter pipe 41, preferably about 1.35 to 1.4 times. The large-diameter pipe 43 may extend forward to the catalyst unit 52.

The large-diameter pipe 43 stabilizes the swirl flow of the mixture gas induced through the tapered pipe 42 and guides the stabilized swirl flow to the catalyst unit 52. The length of the large-diameter pipe 43 suitable for stabilizing and guiding the swirl flow to the catalyst unit 52 may be about 1.5 to 2.5 times the length of the tapered pipe 42, preferably about 1.8 to 2.1 times.

In the swirl forming unit 40, the mixture gas swirls forward. Since the swirl flow receives the force in the centrifugal direction, the swirl flow of the mixture gas is in forward motion while spiraling along the inner circumferential surface of the swirl forming unit 40.

The combustion unit 50 may include an ignition heater unit 51 and a catalyst unit 52.

An ignition heater unit 51 is disposed upstream side of the catalyst unit 52 to induce the ignition of fuel at the initial stage of startup of the carbon dioxide supplier 1. The ignition heater unit 51 is disposed spaced apart from the upstream side of the catalyst unit 52 by a predetermined distance, and accordingly, a swirl retention section D may be provided in the section of the large-diameter pipe 43 between the ignition heater unit 51 and catalyst unit 52. The predetermined distance may be, for example, about 5 cm or more.

The ignition heater unit 51 may operate only in the initial stage, and may not operate after stable ignition.

The ignition heater unit 51 includes a first heater 511 and a second heater 512. Each of the first heater 511 and the second heater 512 is installed in a manner that the first heater 511 and the second heater 512 extend from the side of the large-diameter pipe 43 in a horizontal direction. The first heater 511 is disposed at a position corresponding to ⅔ of the height of the large-diameter pipe, and the second heater 512 is disposed at a position corresponding to ⅓ of the height of the large-diameter pipe. The first heater 511 and the second heater 512 may be installed to extend parallel to each other.

Referring to FIG. 16, the first heater 511 and the second heater 512 extend about 80% to 90% of the total width across the large-diameter pipe 43. That is, the front ends of the first heater 511 and the second heater 512 are not connected to the inner circumferential surface of the large-diameter pipe 43. Thus, the ignition heater unit 51 does not interfere with the swirl movement of the mixture gas occurring in the large-diameter pipe 43.

The first heater 511 and the second heater 512 may have the shape of a flat and long rectangular bar.

The first heater 511 and the second heater 512 are arranged to have a gap of ⅓ of the large-diameter pipe 43 in the radial direction.

Referring to the drawing, the first heater 511 is installed at ⅔ of the total height of the large-diameter pipe 43 when viewed from the front, and the second heater 512 is installed at ⅓ of the total height of the large-diameter pipe 43 when viewed from the front.

Referring to the drawing, when viewed from the front, the direction of the swirl flow is counterclockwise, and the first heater 511 and the second heater 512 may be fixed to the left side surface of the large-diameter pipe 43

Referring to FIG. 15, etc., the second heater 512 is installed in a manner that the flat bar is laid horizontally. On the other hand, the first heater 511 is installed in a manner that the flat bar slightly tilted forward. An angle of inclination j of the first heater 511 may be about 8 to 15 degrees. In the embodiment, it is exemplified that the angle of inclination j is about 10 degrees.

When the flat bar-shaped first heater 511 and second heater 512 are installed to be substantially horizontal, the contact area between the heater and the mixture gas may be sufficiently obtained without interfering with the moving (forward) direction of the swirl flow of the mixture gas.

On the other hand, the first heater 511 is installed to tilt downward by angle of inclination j such that flow of the mixture gas is guided slightly downward as shown in FIG. 15. As the mixture gas burns in the catalyst unit 52, the volume thereof increases and tends to rise upward. Therefore, when both the first heater 511 and the second heater 512 are installed horizontally, the upper portion of the catalyst member 53 is overheated while the central portion of the catalyst member 53 may not be maintained at an appropriate temperature. In particular, while the swirl flow of the mixture gas formed by the swirl forming unit 40 overheats the edge of the catalyst member 53, the amount of combustion in the center portion of the catalyst member 53 is insufficient such that the possibility of the deviation in the mixture gas not being burned evenly in all region of the catalyst member 53 increases.

Accordingly, in the carbon dioxide supplier of the embodiment, by using the heaters 511 and 512 as vanes, the mixture gas is evenly distributed to each grating hole 531 of the catalyst member 53 such that the catalyst member 53 may be heated evenly in overall region. As a result, catalytic combustion may be stably maintained and misfiring may be prevented.

The catalyst unit 52 provided at the front end of the large-diameter pipe 43 is installed in a combustion exhaust pipe 55 connected to the large-diameter pipe 43, and includes a cylindrical catalyst member 53 having a plurality of lattice holes 531 extending in the anteroposterior direction and a gasket 54 surrounding an outer circumference of the catalyst member 53.

The combustion exhaust pipe 55 has an inner diameter corresponding to the large-diameter pipe 43 and is connected to the front end of the large-diameter pipe 43.

The length of the catalyst member 53 in the anteroposterior direction may be determined in a manner that the flow resistance does not rapidly increase while securing a sufficient distance for complete combustion of the mixture gas flowing through the grating hole 531. Referring to FIG. 16, the grating hole 531 may have a square flow cross-section.

The catalyst member 53 may be a porous ceramic catalyst in which ceramic is loaded with platinum (Pt). The catalyst member 53 is activated at a temperature of about 380 degrees Celsius or higher to cause medium temperature combustion of the mixture gas. In addition, the catalyst member 53 post-processes HC and CO generated by incomplete combustion occurring in the ignition heater unit 51 at the initial stage of startup.

The gasket 54 adheres the outer circumferential surface of the catalyst member 53 to the inner circumferential surface of the combustion exhaust pipe 55 such that the mixture gas is not bypassed and discharged without passing through the catalyst member 53.

The mixture gas is burned while maintaining a temperature of about 800 to 950 degrees Celsius by the catalyst member 53. Preferably, the combustion temperature may be maintained at about 900 degrees Celsius. According to the embodiment, such medium temperature combustion may prevent a phenomenon in which NOx is generated during the combustion of the mixture gas.

<The Flow of the Mixture Gas>

Referring to FIG. 16, the mixture gas swirl-flows forward along the inner circumferential surface of the swirl forming unit 40 as shown.

Specifically, the mixture gas introduced into an intro section A swirl-flows along the inner circumferential surface of the tapered pipe 42 at a predetermined velocity v having a lateral velocity component of v×cos k and a forward velocity component of v×sin k. Due to the diffuser shape of the tapered pipe 42, the width of the flow expands from w1 to w2, and moves forward through a speed-up section B. After the swirl-flowing mixture gas is stabilized in a swirl stabilization section C, the swirl-flowing mixture gas continues to move forward through the first heater 511 and the second heater 512 until the forward motion is temporarily retained in a swirl retention section D.

Most of the swirl-flowing mixture gas in the swirl retention section D moves forward along the grating hole 531 of the catalyst member 53 and is combusted, and a portion of the mixture gas flows along the center of the swirl forming unit 40 to return to the rear.

The return flow may occur due to the forward swirl flow of the mixture gas while receiving a centrifugal force along the inner circumferential surface of the swirl forming unit 40. The return flow reaches the dome cap 412 of the small-diameter pipe 41, then joins the mixture gas inlet flow of the intro section A and moves forward again. The dome cap 412 has a curved surface that induces a change in direction of the return flow.

The return flow transfers a portion of the heat of the combustion unit 50 to the rear of the swirl forming unit 40. Accordingly, in the intro section A, the speed-up section B and swirl stabilization section C, the mixture gas may be preheated. Therefore, the cold mixture gas is not able to directly reach the catalyst member 53, and the catalyst combustion is stabilized.

<Assembly of the Catalytic Combustion Device>

The swirl forming unit 40 includes the small-diameter pipe 41, the tapered pipe 42 and the large-diameter pipe 43. One side of the outer circumferential surface of the small-diameter pipe 41 is perforated such that the mixture gas inlet pipe 35 may be connected. The mixture gas inlet pipe 35 is connected to the perforation through welding or the like of the periphery thereof. The angle of inflow k at which the mixture gas inlet pipe 35 is tilted forward may be about 15 to 20 degrees, and the mixture gas inlet pipe 35 is connected to the small-diameter pipe 41 to eb in contact with the circumferential surface of the small-diameter pipe 41 as described above.

The front end of the small-diameter pipe 41 and the rear end of the tapered pipe 42 may be connected to each other by welding or the like. The front end of the small-diameter pipe 41 and the rear end of the tapered pipe 42 may also be connected to each other by a flange structure with a gasket interposed.

The front end of the tapered pipe 42 and the rear end of the large-diameter pipe 43 may be connected to each other by welding or the like. The front end of the tapered pipe 42 and the rear end of the large-diameter pipe 43 may also be connected to each other by a flange structure with a gasket interposed.

The large-diameter pipe 43 may be manufactured by two individual components including a first pipe 431 disposed at the rear and a second pipe 432 disposed at the front. In addition, the first pipe 431 and the second pipe 432 may be connected by a flange structure with a gasket interposed.

According to the embodiment, the mixture gas inlet pipe 35, the small-diameter pipe 41, the tapered pipe 42 and the first pipe 431 may be integrated as one body by welding.

The second pipe 432 and the combustion exhaust pipe 55 provided in front of the second pipe 432 may also be connected by a flange structure with a gasket interposed.

The ignition heater unit 51 is installed in the second pipe 432. Accordingly, the second pipe 432 may be manufactured separately, and the ignition heater unit 51 may then be installed. Thereafter, the second pipe 432 may be connected to the first pipe 431 and the combustion exhaust pipe 55 by a flange structure.

The catalyst unit 52 is installed in the combustion exhaust pipe 55. The catalyst unit 52 may be inserted into the combustion exhaust pipe from front side of the combustion exhaust pipe 55. At the rear end of the combustion exhaust pipe 55, a protrusion extending inward in radial direction may be provided. The catalyst unit 52 may be inserted into the combustion exhaust pipe 55 until the catalyst unit 52 interferes with the protrusion. Accordingly, the insertion depth of the catalyst unit 52 into the combustion exhaust pipe 55 may be accurately controlled.

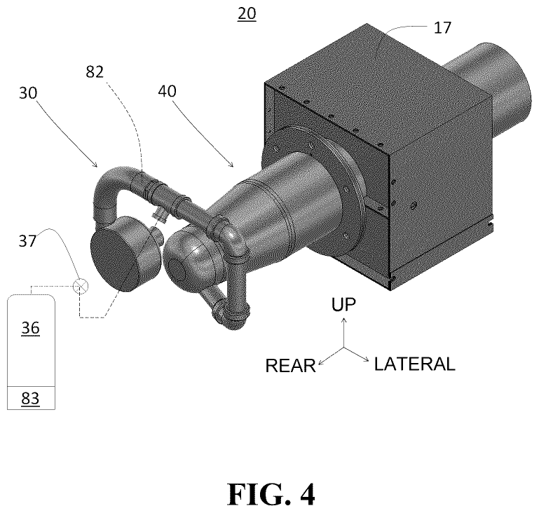

After assembling the catalytic combustion device 20 including the swirl forming unit 40 and the combustion unit 50 in this manner, the catalytic combustion device 20 may be installed on the support bracket 17. Holes are drilled in the front and rear plates of the support bracket 17, and in particular, the rear plate is divided into upper and lower plates as shown in FIG. 4. Therefore, the assembly may be performed by, with the upper plate separated, inserting the combustion exhaust pipe 55 into the front plate of the support bracket 17 from the rear side of the support bracket 17 such that the second pipe 432 sits on the lower plate of the rear plate and then fixing the upper plate of the rear plate.

And in this manner, with the catalytic combustion device 20 installed on the support bracket 17, the support bracket 17 may be installed on the housing to fix the catalytic combustion device 20 onto the housing 10.

<Controller 80>

First, the controller 80 controls the operation of the air supply fan 31 and the opening/closing operation of the valve 37 of the fuel tank 36 to control the air-to-fuel ratio of the mixture gas.

In addition, the controller 80 controls the startup process of the carbon dioxide supplier 1. To this end, the controller 80 controls on/off of the ignition heater unit 51.

The controller 80 also may perform several safety controls.

For these controls, several sensors may be installed in the catalytic combustion device 20.

First, a temperature sensor 81 may be installed at the front end of the catalyst member 53. The temperature sensor 81 may be installed on one of two sides where the mixture gas inlet pipe 35 is installed. This location of the catalyst member 53 is likely to have lowest temperature due to the arrangement of the ignition heater unit 51.

Next, an air volume or flow sensor 82 may be installed in the air supply pipe 32.

In addition, a weight sensor 83 may be installed in the fuel tank 36.

First, the principle of starting the carbon dioxide supplier 1 by the controller 80 will be described. When the user presses the ignition button, the controller 80 first checks whether fuel remains in the fuel tank 36 via the weight sensor 83, and when it is determined that there is sufficient fuel, power is supplied to the ignition heater unit 51 to heat up the ignition heater unit 51, and the air supply fan 31 is turned on at first speed. At this time, the fuel valve 37 is maintained at closed state.

Thereafter, the heat from the ignition heater unit 51 is supplied to the swirl forming unit 40 by the air supply fan 31 to be transferred to the swirl-flowing air, and then to the catalyst member 53. Accordingly, the catalyst member 53 is heated.

The first speed may be a certain speed such that heat from air may be sufficiently transferred to the catalyst member 53 without overheating the ignition heater unit 51.

The temperature sensor 81 detects the temperature of the portion of the catalyst member 53 that is expected to be the lowest. As described above, the process of preheating the catalyst member 53 with the ignition heater unit 51 may be performed until the temperature of the catalyst member 53 detected by the temperature sensor 81 reaches the first set temperature (e.g., 300 degrees Celsius).

When the temperature of the catalyst member 53 exceeds 300 degrees Celsius, the air supply fan 31 operates at a second speed and the fuel valve 37 is opened. Then, the supply of the mixture gas having a set air-to-fuel ratio starts to the swirl forming unit 40. The mixture gas comes into contact with the high-temperature ignition heater unit 51 and is ignited and combusted. The heat from the combustion along with the heat of the ignition heater unit 51 continuously heats the catalyst member 53.

When the temperature of the catalyst member 53 exceeds the second set temperature (eg, 400 degrees Celsius), the controller 80 cuts off the power supplied to the ignition heater unit 51 to turn off the ignition heater unit. Since the catalyst member 53 is activated at approximately 380 degrees Celsius or higher, the continuously supplied mixture gas is combusted even when the ignition heater unit is turned off. That is, the mixture gas flows forward through the grating hole 531 of the catalyst member 53 causing catalytic combustion.

Accordingly, the catalyst member 53 is continuously heated to reach around 900 degrees Celsius, and a steady state is maintained.

According to the embodiment, the supply of fuel starts at the first set temperature before the temperature of the catalyst member 53 reaches its activation temperature (380 degrees Celsius), and the power supply to the ignition heater unit 51 is cut off when the temperature of the catalyst member 53 reaches the second set temperature greater than the activation temperature.

That is, in the interval between the first set temperature lower than the activation temperature of the catalyst member and the second set temperature higher than that of the catalyst member, the ignition heater unit 51 is on and fuel is also supplied. That is, at a temperature equal to or lower than the first set temperature, the ignition heater unit 51 is on, but fuel is not supplied. At a temperature equal to or higher than the first set temperature and equal to or lower than the second set temperature, the ignition heater unit 51 is on and mixture gas is supplied. At a temperature equal to or higher than the second set temperature, the ignition heater unit 51 off and only mixture gas is supplied.

The controller 80 also performs safety controls for startup failure. For example, when the ignition heater unit 51 and the air supply fan 31 are in operation during the startup process, the catalyst member 53 may reach the first set temperature without difficulties. However, when the predetermined process cannot proceed due to reasons such as failure to supply power to the ignition heater unit 51, failure of the ignition heater unit 51, failure of the air supply fan 31 and clogging of the combustion exhaust pipe 55, the catalyst member will not be able to reach the first set temperature. Accordingly, when the temperature of the catalyst member 53 does not reach the first set temperature even after a predetermined time (e.g. 15 minutes) since the startup control of the controller 80, the controller 80 turns on a ignition error lamp 85, issues an alarm, closes the fuel valve 37, and cuts off the power supplied to the ignition heater unit 51.

The controller 80 also detects whether an error has occurred during the operation of the air supply fan 31 and stops the supply of fuel and the operation of the ignition heater unit. Whether the air supply fan 31 operates normally may be directly checked by detecting the air flow rate through the flow sensor 82 installed in the air supply pipe 32. This is a more reliable method than checking an electrical signal from the air supply fan 31 to determine whether the air supply fan 31 is in operation. For example, the controller 80 turns on a fan error lamp 84, issues an alarm, closes the fuel valve 37, and cuts off the power supplied to the ignition heater unit 51 when the amount of supplied air detected by the flow sensor 82 is equal to or lower than a reference value.

Next, the controller 80 continuously checks the amount of remaining fuel. For example, when the amount of remaining fuel detected by the weight sensor 83 is below a reference value, the controller 80 turns on the low fuel lamp 86, issues an alarm, closes the fuel valve 37, and cuts off the power supplied to the ignition heater unit 51.

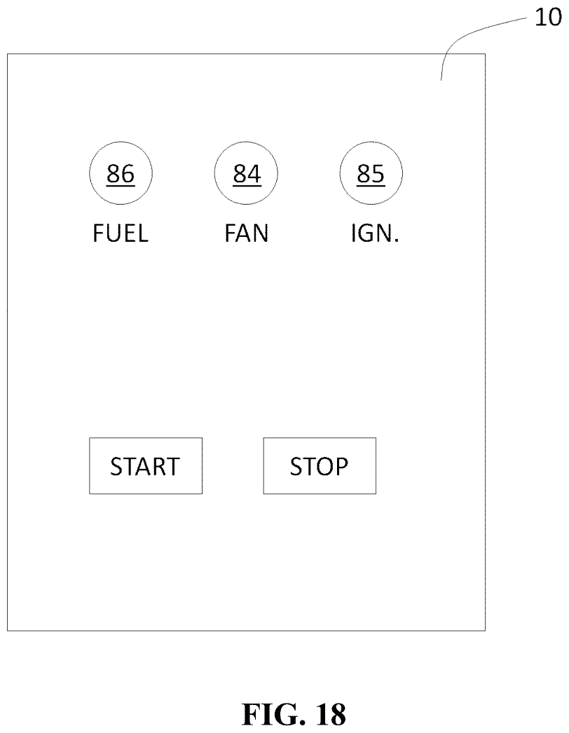

Apparently, the above-described control and alarm of the controller 80 may be performed not only through the control panel and warning lamp shown in FIG. 18, but also through wired, wireless, short-distance, and long-distance communication in a remote server or portable terminal.

<Analysis of the Flow>

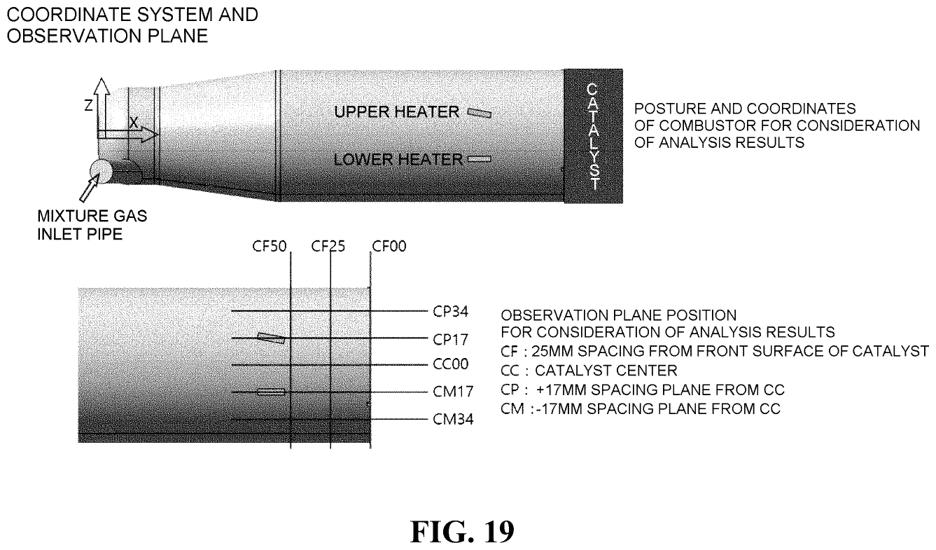

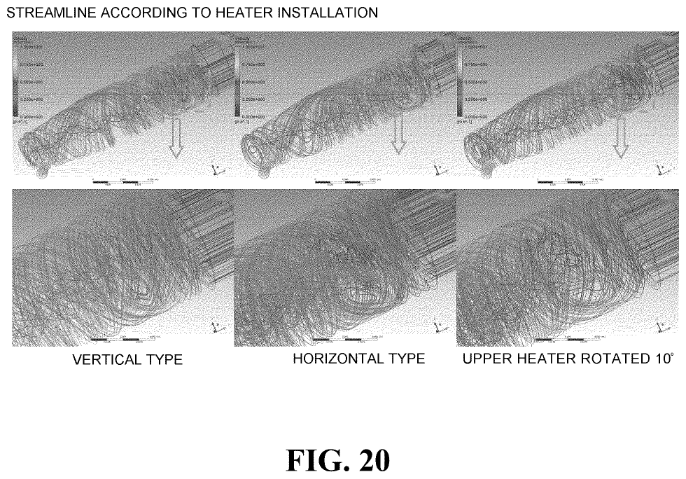

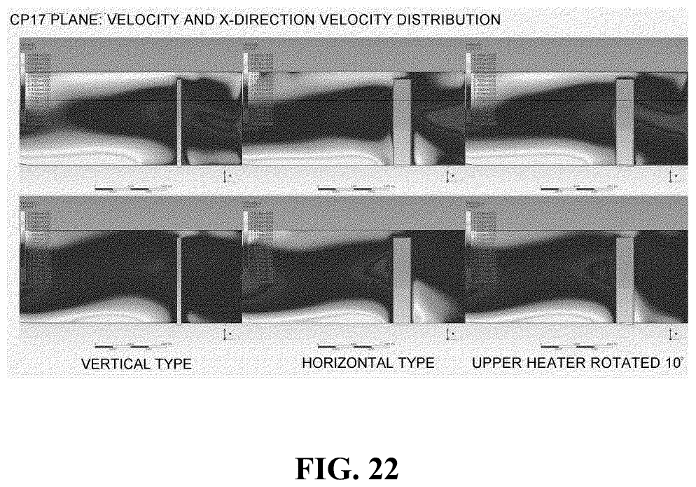

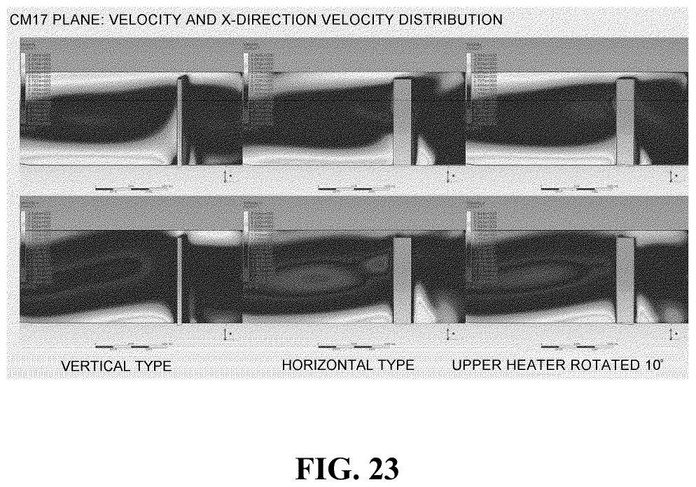

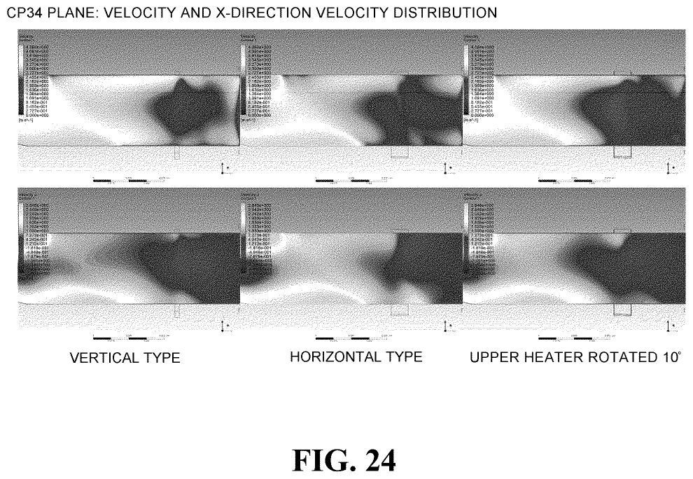

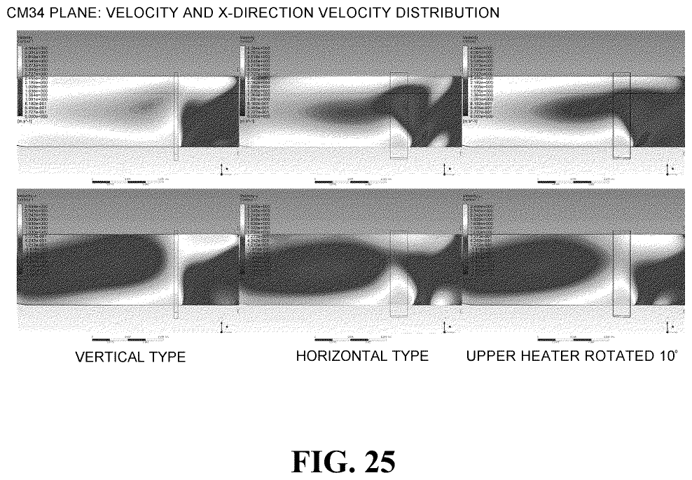

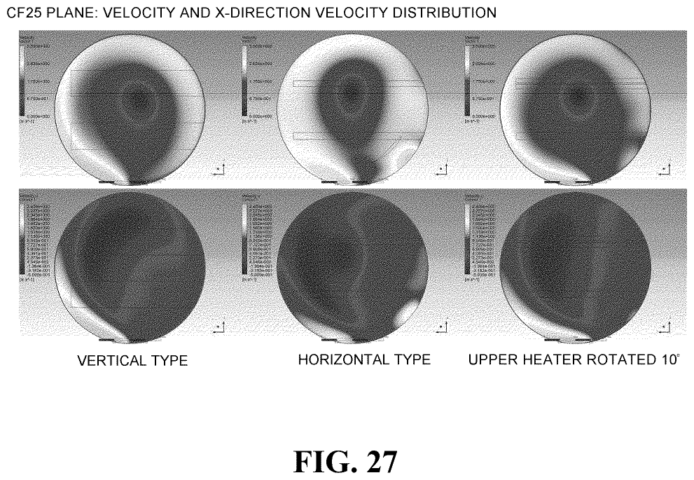

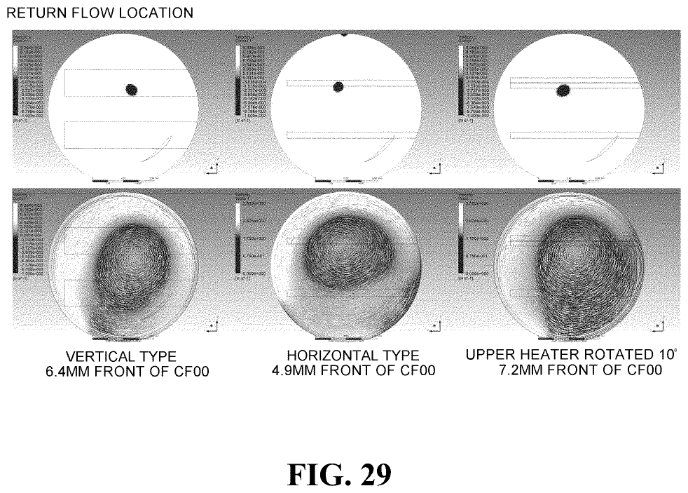

The results of the flow analysis of the mixture gas inside the swirl forming unit in cases where both the flat surfaces of the first heater and the second heater are installed vertically (vertical type) and horizontally (horizontal type), and where the first heater is installed inclined and the second heater is installed horizontally (inclined type) will be described with reference to FIGS. 19 to 29.

The air flow introduced into the mixture gas inlet pipe and spread widely by the tapered pipe reaches the heaters, exchanges heat, and then reaches an area immediately in front of the catalyst member and proceeds forward (towards the outlet) to heat the catalyst.

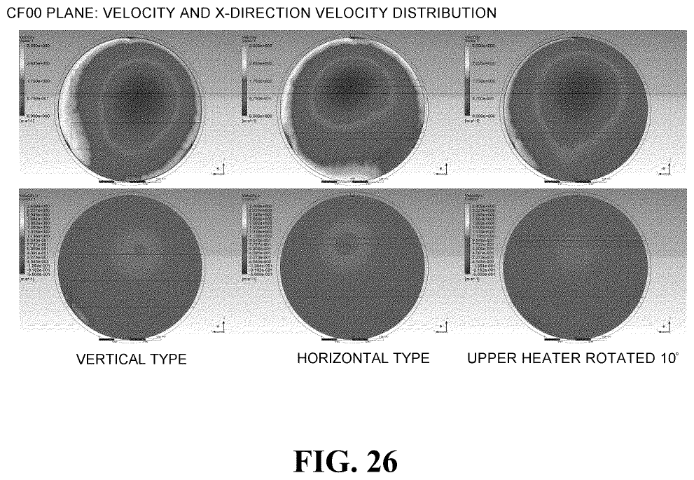

Referring to FIG. 26, the vertical type shows a high flow rate at outer periphery in 10 o'clock direction, while the inclined type shows relatively even distribution without concentration at the outer periphery in 10 o'clock direction. The inclined type shows constant flow rate in overall surface passing through the catalyst with even flow rate distribution, thereby enabling even heating and combustion.

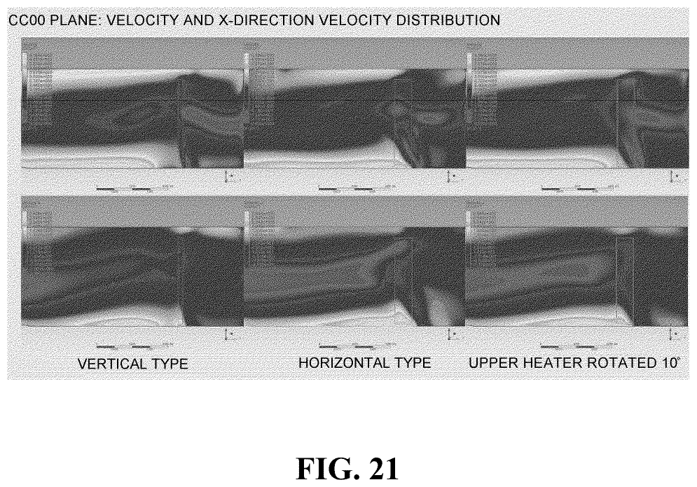

Referring to FIG. 21, a blue region having a negative value represents a reverse airflow. As shown, the starting position of the reverse flow is 6.4 mm before for the vertical type CF00 and 7.2 mm before for the inclined type CF00.

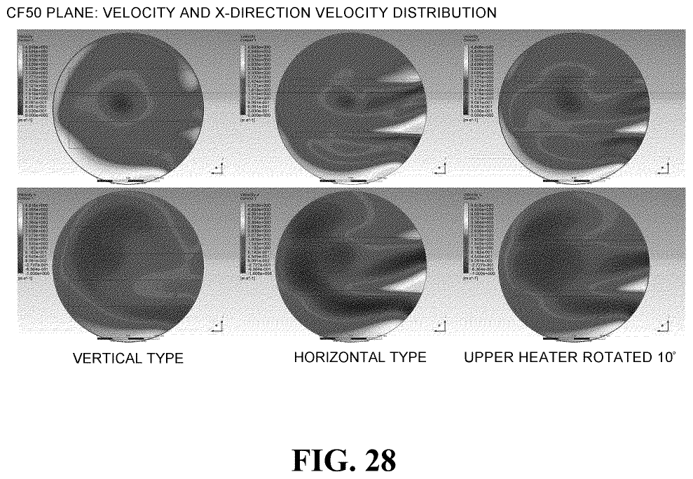

Referring to FIG. 28, the reverse flow varies depending on the installation type of the heater. The inclined type shows stronger reverse flow than the vertical type. Sufficiently preheated reverse flow is mixed with incident air and holds high energy when it reaches the preheating unit.

As LPG is mixed into the air in the mixing pipe to create mixture gas, the mixture gas loses a lot of heat due to the expansion of the mixed LPG. Referring to FIG. 26, the mixture gas introduced into the swirl forming unit in a cooled state supplements heat from the hot return-flowing mixture gas and enters the catalyst in a sufficiently preheated state to enable catalyst combustion.

Still referring to FIG. 26, there is a clear difference in flow between the vertical type and the horizontal type. While the inclined type shows all characteristics of both the vertical and horizontal types, the type of flow immediately before the catalyst member is unique in that the velocity at the outer edge in the radial direction of the catalyst is evenly distributed.

Referring to FIG. 21 from the point of return flow (reverse flow), while the return flow is hindered such that the return flow that has lost kinetic energy cannot not easily proceed in the vertical type (large cross-sectional area in the direction of travel), a relatively strong flow exists in the horizontal type (small cross-sectional area in the direction of travel) with less interference.

Referring to FIG. 26, in the area immediately before the catalyst member, while the horizontal type shows high flow rates at outer periphery in 10 o'clock and 1 o'clock directions similar to the vertical type, the inclined type shows relatively even distribution in the flow rate.

### Modified Example of Heater Installation

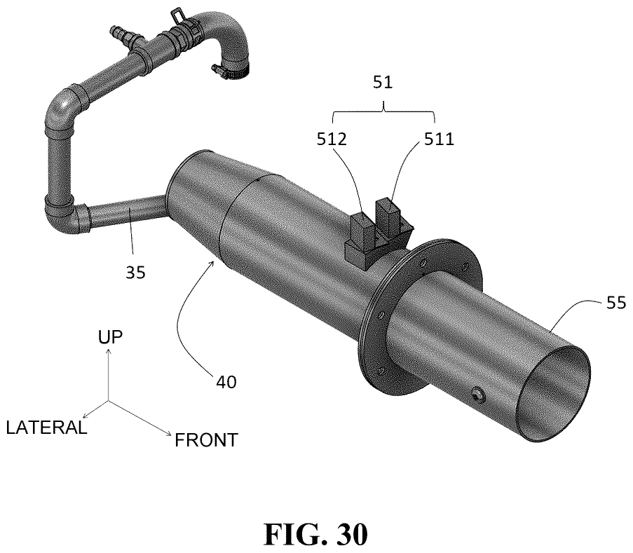

Meanwhile, as a modified example of the installation of the heater 51, referring to FIG. 30, the first heater 511 and the second heater 512 having a flat bar shape may be installed vertically. The first heater 511 and the second heater 512 are located at distance of ⅓ of the diameter of the large diameter pipe 43. That is, the first heater 511 is disposed at a distance of ⅓ of the diameter left from the right end of the large diameter pipe 43, and the second heater 512 is disposed at a distance of ⅓ of the diameter right from the left end of the large diameter pipe 43.

When viewed from the front, the direction of the swirl flow is counterclockwise, and the first heater 511 may be disposed on the right side and the second heater 512 may be disposed on the left side. The first heater 511 and the second heater 512 may be fixed to the upper surface of the large diameter pipe 43.

Also, both the first heater 511 and the second heater 512 may be installed in a slightly obliquely inclined manner corresponding to the direction of the swirl flow. The swirl flow is in counterclockwise direction when viewed from the front of the large diameter pipe 43, and when the observer views the large diameter pipe 43 from the front of the large diameter pipe 43, the swirl flow moves from right to left at the upper portion of the circumferential surface. To correspond to the direction of the swirl flow, the first heater 511 and the second heater 512 having flat bar shape are disposed obliquely to bee inclined to the left toward the front. An angle of inclination of the first heater 511 and the second heater 512 with respect to the anteroposterior direction may be about 8 to 15 degrees. This angle of inclination secures sufficient contact area between the heater and the mixture gas without interfering with the moving direction (forward) of the swirl flow of the mixture gas.

A modified example discloses that the second heater 512 as well as the first heater 511 may be installed obliquely. In addition, the modified example discloses that the first heater 511 and the second heater 512 may be installed to extend not only in the lateral direction, but also in the vertical direction.

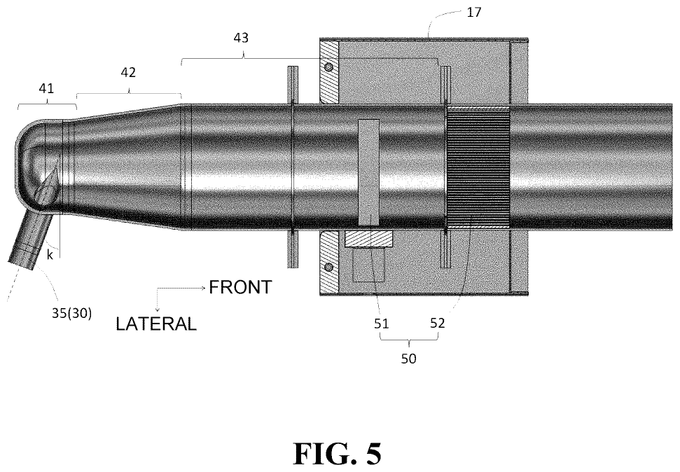

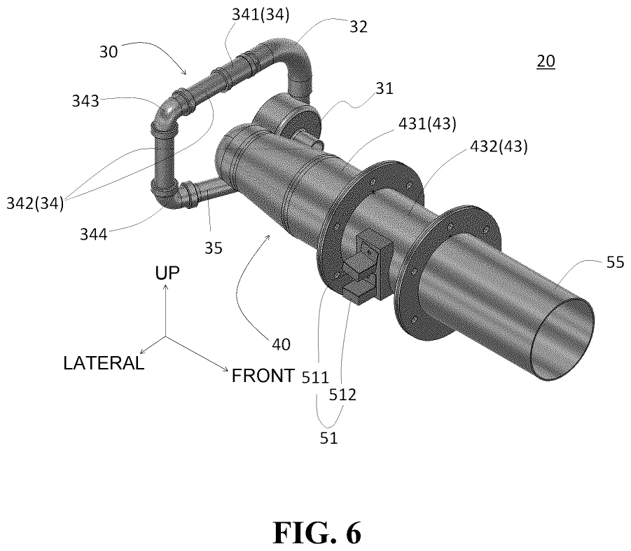

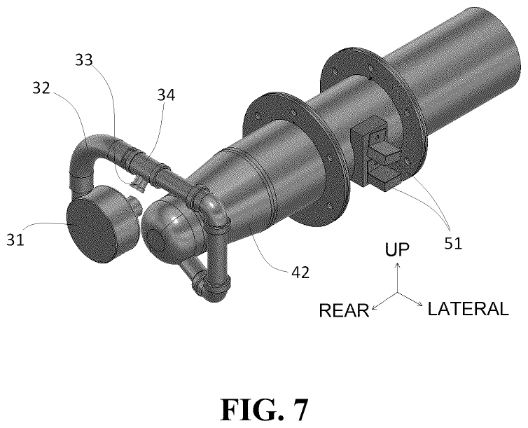

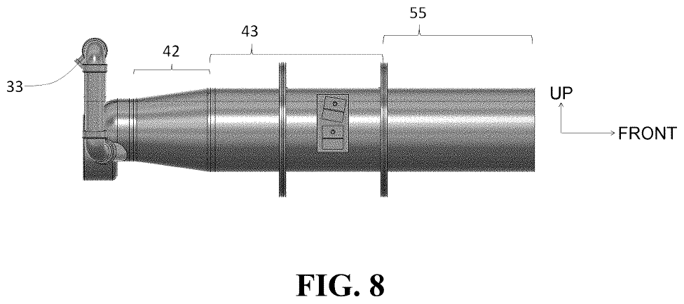

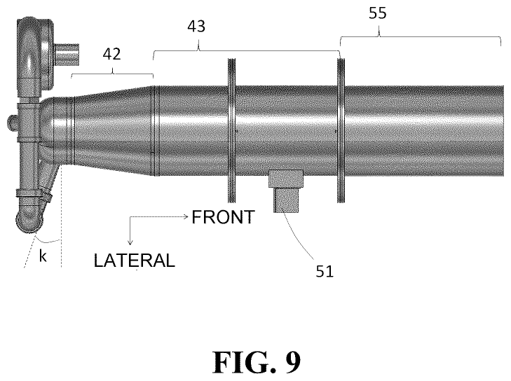

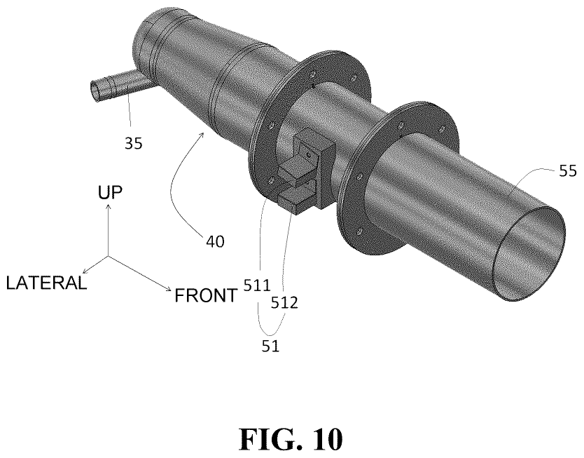

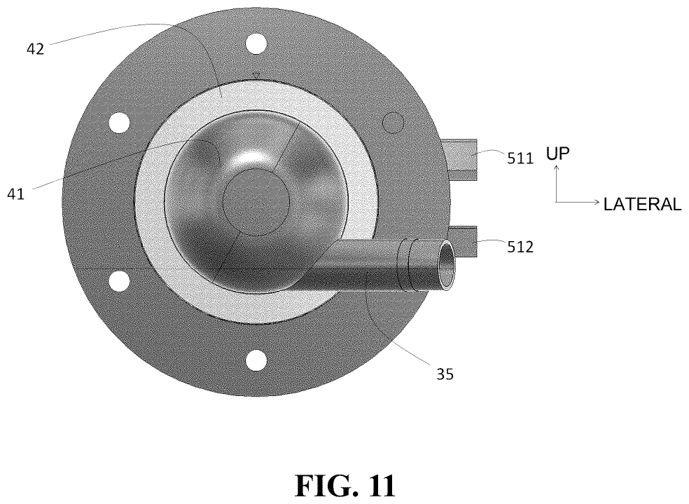

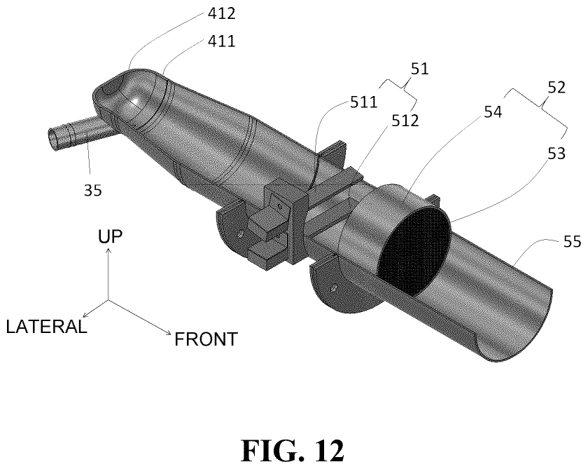

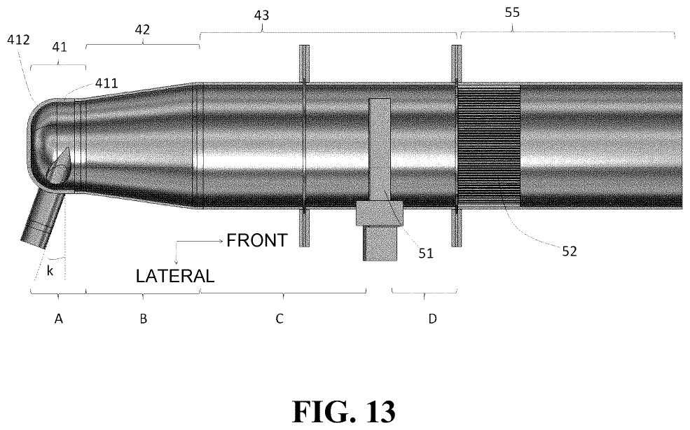

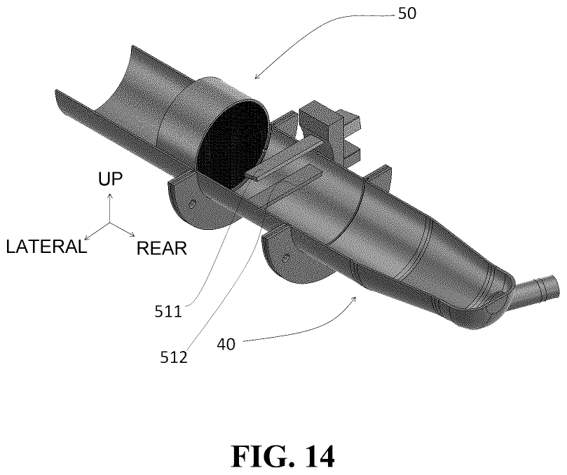

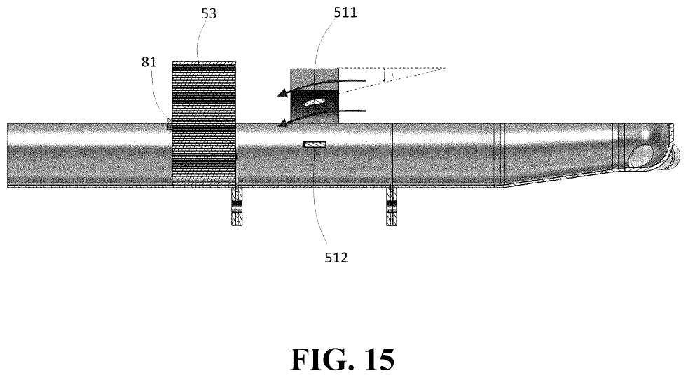

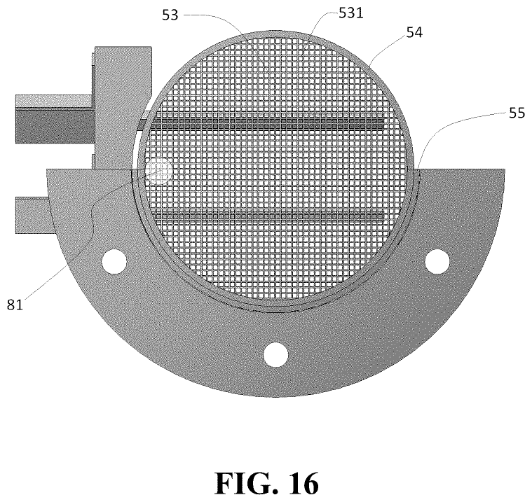

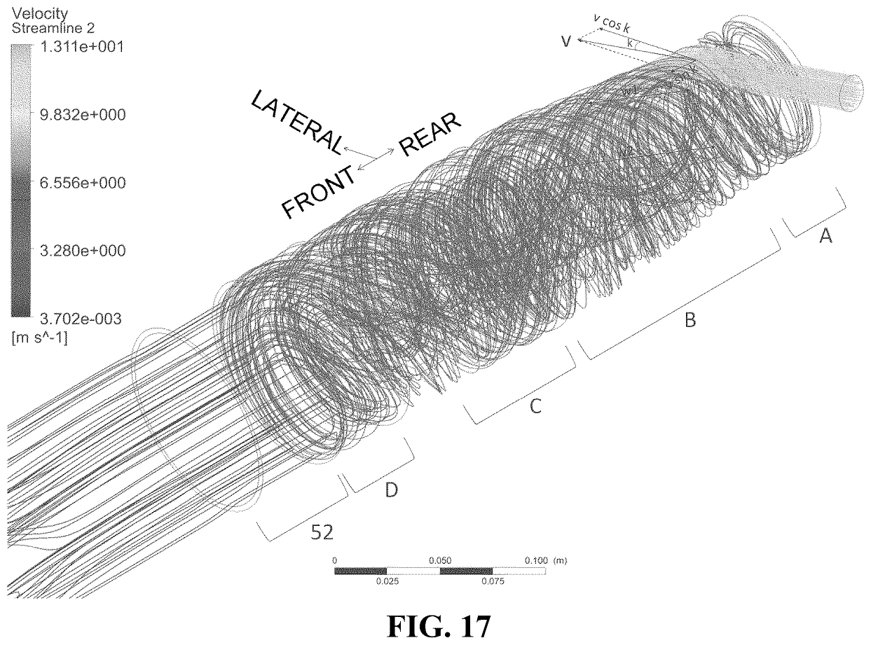

Above-described heater installation structure allows evenly distributed velocity in the portion immediately before the catalyst member at the outer edge in the radial direction of the catalyst without significantly hindering the return flow in terms of return flow. Accordingly, as shown in FIGS. 5 to 16, in case of the first example wherein, among the pair of heaters, the first heater 511 at the upstream side with respect to the direction of the swirl flow is installed obliquely, and the second heater 512 at the downstream side with respect to the direction of the swirl flow is installed in parallel to the anteroposterior direction, the return flow may be further strengthened. On the other hand, as shown in FIG. 30, in case of the second example wherein the pair of heaters is installed obliquely, the velocity in the portion immediately before the catalyst member at the outer edge in the radial direction of the catalyst is more evenly distributed. As a result, a phenomenon in which the temperature rises locally in a specific area may be more reliably prevented.

As described above, while the present invention has been described with reference to the example drawings, the present invention is not limited by the embodiments and drawings disclosed herein, and various modifications may be made by those skilled in the art within the scope of the technical idea of the present invention. In addition, although the effects according to the configuration of the present invention have not been explicitly described while describing the embodiments of the present invention above, the effects predictable by the corresponding configuration should also be recognized.

What is claimed is:

1. A carbon dioxide supplier generating carbon dioxide gas by combusting fuel,
the carbon dioxide supplier comprising:
a mixture gas supply unit 30 supplying a mixture gas of air and fuel;
a combustion unit 50 combusting the mixture gas supplied from the mixture gas supply unit 30; and
a swirl forming unit 40 extending between the mixture gas supply unit 30 and the combustion unit 50 in anteroposterior direction, the swirl forming unit 40 swirl-flowing the mixture gas introduced into a rear portion thereof from the mixture gas supply unit 30 to the combustion unit 50 provided at a front portion thereof,
wherein the swirl forming unit 40 provides a circular flow cross-section along a direction from the mixture gas supply unit 30 toward the combustion unit 50, and
wherein the mixture gas supply unit 30 introduces the mixture gas into the swirl forming unit 40 through a mixture gas inlet pipe 35 connected to the rear portion thereof in a direction inscribed to the circular flow cross-section to form a swirl flow of the mixture gas.

2. The carbon dioxide supplier of claim 1, wherein the mixture gas inlet pipe 35 comprises a straight pipe introducing the mixture gas of straight laminar flow into the swirl forming unit 40.

3. The carbon dioxide supplier of claim 1, wherein the mixture gas inlet pipe 35 connected to the swirl forming unit 40 is inclined forward by a predetermined angle of inflow k with respect to a plane perpendicular to the anteroposterior direction such that the mixture gas supplied from the mixture gas inlet pipe 35 is introduced into the swirl forming unit 40 at a predetermined velocity v having a lateral velocity component of v×cos k and a forward velocity component of v×sin k.

4. The carbon dioxide supplier of claim 3, wherein a tapered pipe 42 having an inner diameter increasing toward a forward direction is provided at a portion of the swirl forming unit 40 further forward than where the mixture gas inlet pipe 35 is connected such that a width of the swirl flow of the mixture gas introduced from the mixture gas inlet pipe 35 is increased.

5. The carbon dioxide supplier of claim 4, wherein a large-diameter pipe 43 having a constant inner diameter and extending in forward direction is connected to a front portion of the tapered pipe 42 to provide a swirl stabilization section C such that the swirl flow of the mixture gas in forward motion through the tapered pipe 42 is stabilized.

6. The carbon dioxide supplier of claim 3, wherein a dome cap 412 having an inner surface concaved toward backward direction is provided at a portion of the swirl forming unit 40 further backward than where the mixture gas inlet pipe 35 is connected.

7. The carbon dioxide supplier of claim 1, wherein the combustion unit 50 comprises:
a catalyst member 53 installed at a front end of the swirl forming unit 40 and having a plurality of lattice holes 531 extending and penetrating through in the anteroposterior direction; and
an ignition heater unit 51 spaced apart from a rear end of the catalyst member 53 in a backward direction by a predetermined distance,
wherein a space corresponding to the predetermined distance constitutes a swirl retention section D where the swirl flow of the mixture gas retains.

8. The carbon dioxide supplier of claim 7, wherein the ignition heater unit 51 includes a first heater 511 having flat bar-shape and a second heater 512 having flat bar-shape,
each of the first heater 511 and the second heater 512 provided at a same position with respect to the anteroposterior direction,
each of the first heater 511 and the second heater 512 extending in a direction perpendicular to the anteroposterior direction,
extending direction of the first heater 511 being parallel to that of the second heater 512, and
each of front ends of the first heater 511 and the second heater 512 being spaced apart from an inner circumferential surface of the swirl forming unit 40.

9. The carbon dioxide supplier of claim 8, wherein at least one of the first heater 511 having flat bar-shape and the second heater 512 having flat bar-shape is installed at a predetermined angle of inclination j with respect to the anteroposterior direction corresponding to a direction of the swirl flow.

10. The carbon dioxide supplier of claim 1, wherein
the combustion unit 50 comprises:
a catalyst member 53 installed at a front end of the swirl forming unit 40 and promoting combustion of the mixture gas at a temperature higher than an activation temperature; and
an ignition heater unit 51 disposed further backward than the catalyst member 53,
the carbon dioxide supplier 1 further comprising:
a temperature sensor 81 detecting a temperature of the catalyst member 53; and
a controller 80 controlling the mixture gas supply unit 30 and the ignition heater unit 51,
wherein the controller 80 performs, for a startup of the carbon dioxide supplier,
a preheating step of supplying power to the ignition heater unit 51 to generate heat and of controlling the mixture gas supply unit 30 to supply air until the temperature of the catalyst member 53 reaches a first set temperature lower than the activation temperature;
an overlapping step of maintaining power supply to the ignition heater unit 51 and controlling the mixture gas supply unit 30 to supply the mixture gas when the temperature of the catalyst member 53 is equal to or higher than the first set temperature and equal to or lower than a second set temperature higher than the activation temperature; and
an operating step of cutting off the power supplied to the ignition heater unit 51 to stop generating heat and controlling the mixture gas supply unit 30 to supply the mixture gas when the temperature of the catalyst member 53 is equal to or higher than the second set temperature.
